(19) United States
(12) Patent Application Publication
(10) Pub. No.: US 2011/0062735 A1
(43) Pub. Date: Mar. 17, 2011

(54) PROTECTIVE KICK STRIP

(76) Inventors: Harold G. Erickson, Mukilteo, WA (US); Paul T. Bridgeman, Mill Creek, WA (US); Bryan A. Branscome, Camano Island, WA (US); Bobbie L. Cole, Mukilteo, WA (US); Gregory W. Nelson, Everett, WA (US); Mark W. Whalon, Everett, WA (US)

(21) Appl. No.: 12/559,633

(22) Filed: Sep. 15, 2009

(51) Int. Cl. E06B 7/28; B60J 9/00

(52) U.S. Cl. 296/1.07; 16/402

(57) ABSTRACT

In one embodiment, a kickstrip assembly comprises a base plate having a length extending along a longitudinal axis, and comprising an upper segment having an upper edge and an upper lip, a lower segment having a lower edge and a lower lip, the upper lip and the lower lip defining a middle section. The assembly further comprises an insert formed from a flexible polymeric material and comprising a faceplate, an upper edge depending from the faceplate, and a lower edge depending from the faceplate, wherein the faceplate is dimensioned to fit within middle section of the base plate.

### FIELD OF THE DISCLOSURE

This invention relates to moldings, and more particularly to molding assemblies useful in aircraft or other vehicles.

### BACKGROUND

Vehicles such as aircraft, buses, ships, and the like may utilize moldings, also sometimes referred to as kick strips, secured to walls, corners, or other features of the cabin. Such moldings may be purely decorative or may be protective. Accordingly, molding designs may find utility in various vehicles including aircrafts, buses, ships and the like.

### SUMMARY

In various aspects, protective kick strips are provided. In some embodiments, protective kick strips may be mounted on a wall or other structure in an aircraft, bus, ship, or other vehicle as a decorative ornament and/or to protect the wall or other structure from damage caused by impact from an object.

Thus, in one aspect there is provided a kickstrip assembly. The assembly comprising a base plate having a length extending along a longitudinal axis, and comprising an upper segment having an upper edge and an upper lip, and a lower segment having a lower edge and a lower lip. The upper lip and the lower lip define a middle section. The assembly further comprises an insert formed from a flexible polymeric material and comprising a faceplate, an upper edge depending from the faceplate, and a lower edge depending from the faceplate. The faceplate is dimensioned to fit within middle section of the base plate.

In another aspect there is provided an a vehicle, comprising a body defining an interior cabin, and a kickstrip assembly secured to a wall section of the cabin. The assembly comprising a base plate having a length extending along a longitudinal axis, and comprising an upper segment having an upper edge and an upper lip, and a lower segment having a lower edge and a lower lip. The upper lip and the lower lip define a middle section. The assembly further comprises an insert formed from a flexible polymeric material and comprising a faceplate, an upper edge depending from the faceplate, and a lower edge depending from the faceplate. The faceplate is dimensioned to fit within middle section of the base plate.

The features, functions and advantages discussed herein can be achieved independently in various embodiments described herein or may be combined in yet other embodiments, further details of which can be seen with reference to the following description and drawings.

### BRIEF DESCRIPTION OF THE DRAWINGS

The detailed description is described with reference to the accompanying figures.

FIG. 1 is a schematic, exploded perspective illustration of a protective kick strip assembly in accordance with some embodiments.

FIG. 2 is a schematic, exploded side illustration of a protective kick strip assembly in accordance with some embodiments.

FIG. 3 is a schematic, side illustration of an assembled protective kick strip assembly in accordance with some embodiments.

FIG. 4 is a schematic frontal illustration of an assembled protective kick strip assembly in accordance with some embodiments.

FIG. 5 is a schematic illustration of an aircraft in which a protective kickstrip assembly may be installed, according to embodiments.

### DETAILED DESCRIPTION

Described herein are exemplary protective kickstrip assemblies and vehicles comprising such assemblies. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

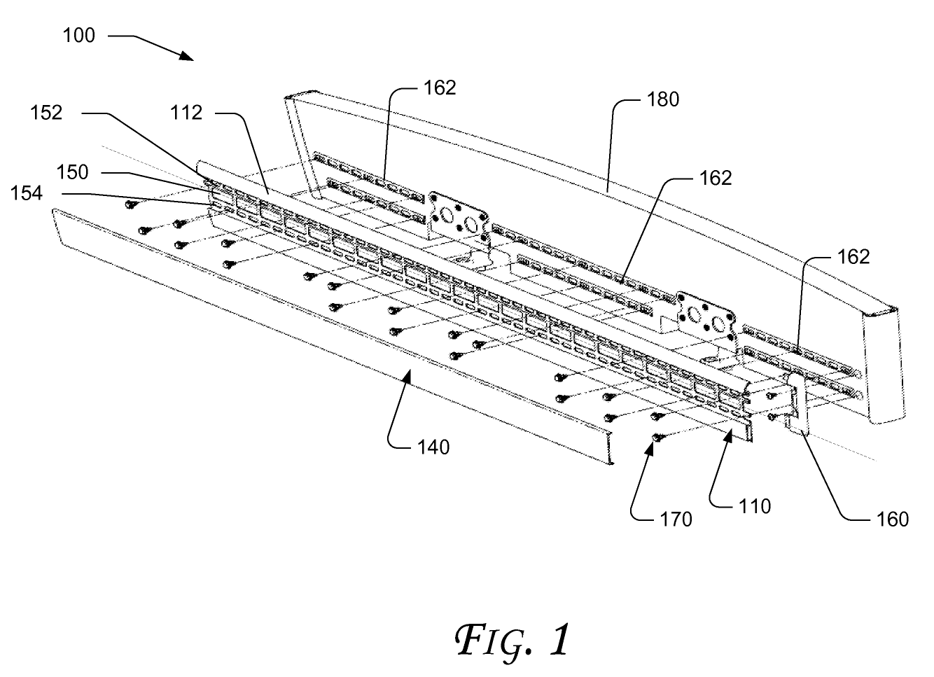

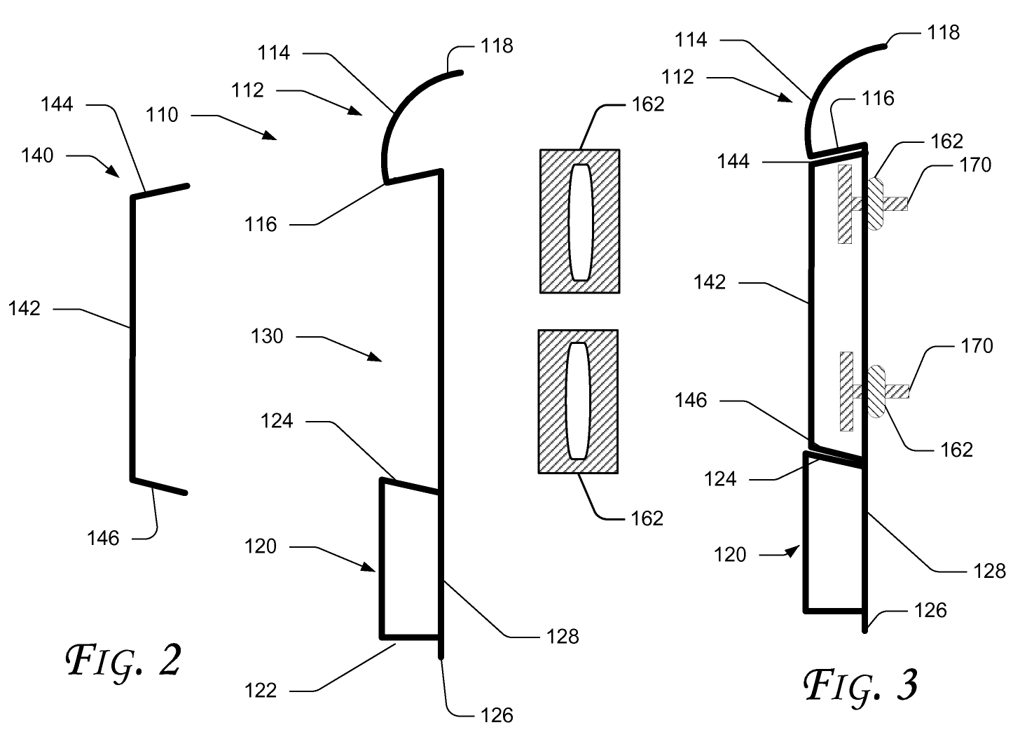

FIG. 1 is a schematic, exploded perspective illustration of a protective kick strip assembly 100 in accordance with some embodiments, and FIG. 2 is a schematic, exploded side illustration of a protective kick strip assembly in accordance with some embodiments. Referring to the embodiment depicted in FIGS. 1 and 2, the kickstrip assembly 100 comprises a base plate 110 having a length extending along a longitudinal axis. Base plate 110 comprises an upper segment 112 having an upper edge 114 and an upper lip 116. Base plate 110 further comprises a lower segment 120 having a lower edge 122 and a lower lip 124 depending from the lower edge 122. The upper lip 116 and the lower lip 124 define a middle section 130 of the base plate 110.

Referring to FIG. 1, the base plate 110 comprises a first row of apertures 150 extending along the longitudinal axis. In the embodiment depicted in FIG. 1, the apertures 150 extend along substantially the entire length of the base plate 110, and serve to reduce the weight of the base plate 110. Base plate 110 further comprises a second row 152 of apertures adjacent the first row, and a third row 154 of apertures adjacent the first row. In the embodiment depicted in FIG. 1, the second row 152 and third row 154 of apertures also extend along substantially the entire length of the base plate 110, and serve to reduce the weight of base plate 110 and to provide guide holes through which fasteners 170 may be passed to secure the base plate 110 to a structure such as a wall 180.

In some embodiments, the assembly 100 may further comprise one or more spacer elements 162 which may be interposed between the base plate 110 an a structure such as a wall 180. Further, the assembly 100 may comprise one or more end caps 160 adapted to connect to the base plate 110, and an insert 140. Referring to FIG. 2, the insert 140 comprises a faceplate 142, which has an upper edge 144 and a lower edge 146 depending from the faceplate.

FIG. 3 is a schematic, side illustration of an assembled protective kick strip assembly in accordance with some embodiments. Referring to FIG. 3, in assembly, the base plate 110 is secured to a structure such as a wall 180 using one or more fasteners 170, and the insert 140 is inserted into the base plate 110 between the upper lip 116 and the lower lip 124. The base plate 110 comprises a back edge 128 defining a plane. In one embodiment, the upper edge 114 comprises a tail section 118 that extends beyond the plane defined by the back edge 128. In use, when the base plate 110 is secured to a structure such as a wall 180, the tail section 118 of the upper segment 112 urges the upper lip 116 toward the lower lip 124, thereby compressing the insert 140 between the upper lip and the lower lip. In some embodiments, the insert 140 is formed from a flexible polymeric material, such that compressing the insert between the upper lip 116 and the lower lip 124 causes the insert 140 to flex along a longitudinal axis, which in turn enables the insert 140 to provide a spring-like cushion effect against impact by foreign objects.

Further, when the kick plate assembly 100 is installed proximate a floor, the flange 126 provides a seal between the kick plate assembly 100 and the floor, such that fluids spilled on the floor are inhibited from seeping onto the wall, where they may be absorbed.

Base plate 110 and insert 140 may be formed from any suitable material. In some embodiments, base plate 110 and insert 140 may be formed from a suitable material, e.g., a suitable polymer such as a thermoplastic or metal such as aluminum by a suitable process such as a thermal extrusion process or a rolling process or a stamping process. Similarly, the fasteners 170 may be formed from a suitable polymer or metal. End caps 160 may be formed from a suitable polymer material and injection molded or from a suitable metal and molded or formed.

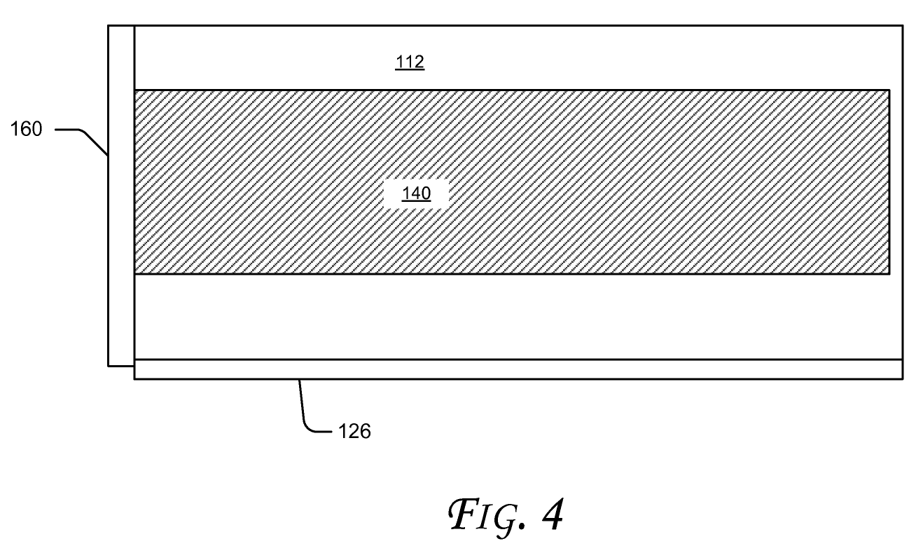

FIG. 4 is a schematic frontal illustration of an assembled protective kick strip assembly in accordance with some embodiments. Referring to FIG. 4, when assembled the insert 140 is secured between the upper segment 112 of the base plate 110 and the lower segment 120 of the base plate 110. The flange 126 extends from the lower segment 120 of the base plate 120.

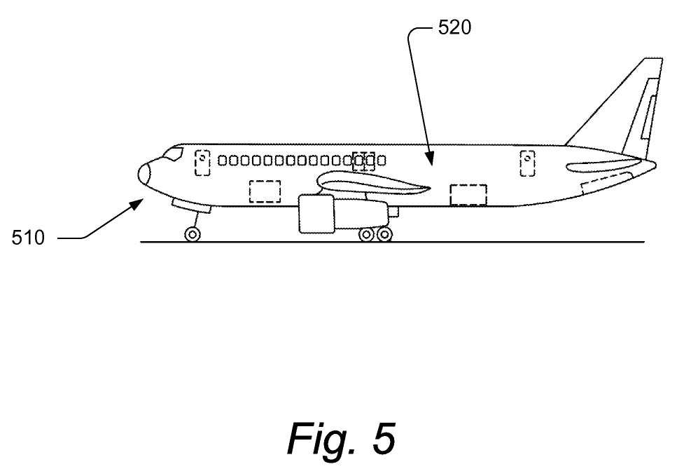

In use, the kick strip assembly 100 may be mounted to a wall or other structure on the interior of a vehicle such as, e.g., an aircraft, a bus, or a ship. FIG. 5 is a schematic illustration of an aircraft 510 in which a protective kickstrip assembly may be installed, according to embodiments Referring to FIG. 5, the airplane 510 may be a commercial airline, cargo plane, or small passenger plane. The airplane 510 may comprise a body 520 which defines an interior cabin. One or more kick strip assemblies 100 may be mounted on a structure of the interior cabin.

Thus, as described herein one or more interior walls or structures of an aircraft may be equipped with a kick strip assembly 100. In some embodiments the kick strip assembly may be purely decorative, while in other embodiments the kick strip assembly may provide protection against impact by objects.

Reference in the specification to “one embodiment” or “some embodiments” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A kickstrip assembly, comprising:
a base plate having a length extending along a longitudinal axis, and comprising:
an upper segment having an upper edge and an upper lip;
a lower segment having a lower edge and a lower lip;
the upper lip and the lower lip defining a middle section; and
an insert formed from a flexible polymeric material and comprising:
a faceplate;
an upper edge depending from the faceplate; and
a lower edge depending from the faceplate;
wherein the faceplate is dimensioned to fit within middle section of the base plate.

2. The kickstrip assembly of claim 1, wherein the base plate comprises a first row of apertures extending along the longitudinal axis.

3. The kickstrip assembly of claim 2, wherein the base plate comprises a second row of apertures adjacent the first row, and a third row of apertures adjacent the first row.

4. The kickstrip assembly of claim 1, further comprising at least one endcap configured to mate with the base plate.

5. The kickstrip assembly of claim 1, further comprising at least one spacer element.

6. The kickstrip assembly of claim 1, wherein the lower segment comprises a flange extending from a lower surface.

7. The kickstrip assembly of claim 1, wherein the base plate is secured to a structure by a plurality of fasteners.

8. The kickstrip assembly of claim 7, wherein:
the base plate comprises a back edge defining a plane; and
the upper edge comprises a tail section that extends beyond the plane defined by the back edge,
whereby, when the base plate is secured to the structure the upper segment urges the upper lip toward the lower lip, thereby compressing the insert between the upper lip and the lower lip.

9. The kickstrip assembly of claim 8, wherein the insert is formed from a flexible polymeric material, such that compressing the insert between the upper lip and the lower lip causes the insert to flex along a longitudinal axis.

10. A vehicle, comprising:
a body defining an interior cabin;
a kickstrip assembly secured to a wall section of the cabin; and comprising:
a base plate having a length extending along a longitudinal axis, and comprising:
an upper segment having an upper edge and an upper lip;
a lower segment having a lower edge and a lower lip;
the upper lip and the lower lip defining a middle section; and
an insert formed from a flexible polymeric material and comprising:
a faceplate;
an upper edge depending from the faceplate; and
a lower edge depending from the faceplate;
wherein the faceplate is dimensioned to fit within middle section of the base plate.

11. The vehicle of claim 10, wherein the base plate comprises a first row of apertures extending along the longitudinal axis.

12. The vehicle of claim 11, wherein the base plate comprises a second row of apertures adjacent the first row, and a third row of apertures adjacent the first row.

13. The vehicle of claim 10, further comprising at least one endcap configured to mate with the base plate.

14. The vehicle of claim 10, further comprising at least one spacer element.

15. The vehicle of claim 10, wherein the lower segment comprises a flange extending from a lower surface.

16. The vehicle of claim 10, wherein the base plate is secured to a structure by a plurality of fasteners.

17. The vehicle of claim 16, wherein:
the base plate comprises a back edge defining a plane; and
the upper edge comprises a tail section that extends beyond the plane defined by the back edge,
whereby, when the base plate is secured to the structure the upper segment urges the upper lip toward the lower lip, thereby compressing the insert between the upper lip and the lower lip.

18. The vehicle of claim 17, wherein the insert is formed from a flexible polymeric material, such that compressing the insert between the upper lip and the lower lip causes the insert to flex along a longitudinal axis.

19. The vehicle of claim 10, wherein the vehicle comprises at least one of an aircraft, a bus, or a ship.
